(19) United States
(12) Patent Application Publication
(10) Pub. No.: US 2016/0288981 A1
(43) Pub. Date: Oct. 6, 2016

(54) CONTAINER FOR STORING AND PREPARING FOOD

(71) Applicant: Maurizio FESTA, Karlsruhe (DE)

(72) Inventor: Maurizio FESTA, Karlsruhe (DE)

(21) Appl. No.: 15/036,442

(22) PCT Filed: Oct. 16, 2014
(86) PCT No.: PCT/EP2014/072246

§ 371 Date: May 13, 2016

(30) Foreign Application Priority Data
Dec. 17, 2013 (EP) 13197789.4

(51) Int. Cl. B65D 81/34; A47J 27/04; B65D 81/32; B65D 25/08; B65D 81/38

(52) U.S. Cl. CPC B65D 81/3438; B65D 25/08; B65D 81/382; B65D 81/32; A47J 27/04; A47J 2027/043

(57) ABSTRACT

In the past, in order to increase the quality of food which is pre-produced so as to be ready for consumption and must only be heated, the individual components started being stored in separate sub-areas of a container so that the components come into contact with each other only shortly before being consumed. For example, by folding one of the sub-areas and emptying the sub-area into the other sub-area, pasta and a sauce for example could be mixed together when using such solutions. The aim of the invention is to simplify the handling of such products in particular during the mixing process. This is achieved in that a container interior is separated by a partition which then separates the components. By simply pulling out the partition, the components can be mixed together. Furthermore, such a partition can be prepared for a gentle and efficient vapor heating process.

The invention relates to a container for storage and preparation of foods, which encloses an interior and comprises a container mantle and a container bottom, wherein the interior is divided into at least two sub-areas that are insulated from one another in liquid-tight manner, using at least one partition, wherein the partition can be removed from the interior, in destruction-free manner, so that the liquid-tight reciprocal insulation of the sub-areas is given up, and a connection between the sub-areas is produced.

Such an object is already previously known from the document WO 2013/014345 A1. There, a plate-shaped container is provided, which is covered by a film/foil. Along with the film/foil, a partition can be removed, which projects into the container perpendicular from the film/foil, and thereby places a connection section between two sub-areas of the container, forming a seal, before the film/foil is removed.

Such containers are known from the state of the art in many different ways. They are used for the most varied foods, some of which are planned to be heated; in other cases, such containers are in use, in different ways, in connection with yogurt cups, for example. In every case, the fundamental, underlying idea is that foods are provided in a form in which they are at first separated from one another, so that mixing of the foods can be carried out by the consumer himself/herself. This promises greater freshness of the product, for one thing, because complete penetration of the one product part with the other product part has not yet taken place, and for another thing, the consumer is given the opportunity to act on mixing of the separate products to his/her own taste.

Known yogurt cups, which are divided into two sub-areas, are a particularly known example of such a container, wherein one sub-area is assigned to the other so as to move by way of a bending fold. By bending the one sub-area around the bending fold, its content can be emptied into the other sub-area, so that mixing of the two product parts can be undertaken, preferably in the larger sub-area.

Likewise, a configuration is known from the state of the art, in which the second, usually smaller sub-area is implemented as a cup set into another, which cup can be completely removed from the larger cup. In this way, in contrast to the solution mentioned above, the space of the smaller cup is additionally available for the product, so that the problem of possible overfilling of the cup when the product parts are combined does not have to be taken into consideration during filling.

Therefore, it is problematical in connection with the first solution, at first, that the second sub-area is no longer available for the product at the end, and therefore sufficient free space must be kept clear. In the second solution from the state of the art, the problem consists in completely emptying the second smaller cup, which can be removed from the larger cup part, so that complete consumption of the product contained in it is possible.

Against this background, the present invention is therefore based on the task of proposing a container for storage and preparation of foods, in which the available space of the cup can be completely utilised, for one thing, and for another thing, the complete product can be utilized, if possible without residues.

This task is accomplished by a container for storage and preparation of foods in accordance with the characteristics of claim 1. Further practical embodiments of such a container can be derived from the dependent claims.

According to the invention, it is provided that a partition is disposed between the two sub-areas, which are insulated from one another in liquid-tight manner, which partition can be removed from the interior in destruction-free manner. By removal of the partition from the interior, the two sub-areas are supposed to be connected with one another, wherein the liquid-tight reciprocal insulation of the sub-areas is given up. In other words, a partition is pulled out more or less upward out of two adjacent sub-areas of a container, so that the contents of the two sub-areas can flow into one another. As a result, the complete interior of the container is now available for the product and for the container; furthermore, the product of the two sub-areas, which adheres to the wall, can also be completely utilized by mixing the product and, at the same time, thereby stripping it from the walls. This results in significantly more efficient utilization of the container content for the consumer.

In detail, a groove can be assigned to the container mantle and/or to the container bottom, in which groove the partition or parts of it is/are accommodated. As a result, a better seal of the connection between the partition wall and the container bottom or the container mantle is guaranteed, so that penetration of the product parts is avoided when the partition is in place. The consumer can therefore combine a chamber filled with pasta, on the one hand, with a chamber filled with a sauce, on the other hand, for example, by simply pulling out the partition when the liquid seal is in effect, and can mix the two product parts with one another in the resulting total interior. The same can also be performed with other products, for example with the components of a cappuccino or of a yogurt.

In order to simplify introduction of the partition into a groove that is provided, the partition can have a tongue along its outer edges, which is suitable for being introduced into the groove of the container mantle and/or of the container bottom. In this way, an additional labyrinth effect is obtained in the region of the joined edges of the partition and of the container, so that greater tightness can be guaranteed. The path to be crossed for penetration of this connection clearly becomes longer.

On its side facing away from the container bottom, the partition can furthermore have a reinforcement element that is supposed to prevent bending of the partition. The reinforcement element can either be formed onto the partition or can be formed by means of a fold, for example. Ideally, the reinforcement element, together with the partition, can form either an L shape or a T shape in cross-section. However, other reinforcement elements on the partition are also possible, by means of being formed on or folded, and are explicitly also covered by the invention.

In particular in view of the circumstance that the contents of the container might have to be heated before being consumed, the container mantle and/or the container bottom can have an insulation that can be formed, for example, by an insulation core. In this regard, the container mantle and/or the container bottom consist(s) of an outer wall and an inner wall, which enclose this insulation core between them. The container is then, configured to be hollow and filled with a gas, for example with air, or has a heat-insulating solid or liquid core in this cavity. On the basis of this insulation, the product situated in the container and to be heated cannot cause burns on the hands of the consumer holding the container, even at higher temperatures, and cools less rapidly.

Aside from the widespread possibility of heating foods using microwaves, which are particularly used also in the sector of ready-to-eat prepared foods, the possibility exists of heating the product in significantly gentler manner, using steam. In this regard, the problem regularly exists of allowing uniform penetration of the product, as complete as possible, with steam. In a practical further development, the invention provides, in this regard, that a steam pipe is assigned to the partition, which pipe particularly runs from the edge that faces away from the container bottom, in the direction of the container bottom. Such a steam pipe is accessible by way of a steam entry, at the edge facing away from the container bottom, and has a steam outlet in the region of the container bottom. The steam, which enters into the product far down, therefore passes through the product from bottom to top, since the steam rises upward because of its natural convection and thermodynamic expansion, or also because of a steam pressure that is applied.

In order to ensure that penetration of the two product parts cannot also take place by way of the steam outlet of the steam pipe, it is quite advantageous if the steam pipe has at least one pipe partition, which divides the steam pipe in completely liquid-tight manner. In this regard, the pipe partition can run either up to the top edge of the steam pipe, or can already break off below the top edge of the steam pipe, in order to allow insertion of a steam feed into the steam pipe. Fundamentally, it is provided that the steam pipe is conducted all the way to the top edge of the partition.

In detail, it is provided that the steam pipe is a cylindrical or polygonal pipe, which narrows in a suitable shape, for example a spherical shape, conical shape, or truncated conical shape in the region of the container bottom. In the spherical, conical or truncated conical region, in other words in the region of the steam outlet, the steam pips has at least one steam exit opening, in this regard, by way of which the steam introduced into the steam pipe through the steam entry can optionally penetrate into one of the two sub-areas or into both sub-areas.

In an advantageous further development, a connection means can be assigned to the steam entry, by way of which means the steam feed device can be connected with the container. This can be a steam-tight connection, into which the steam feed is inserted, but a screw connection or the like is also fundamentally possible. Furthermore, a stress-relief opening can be provided, for example by means of pre-perforation, through which opening the steam can escape, if necessary, when a steam pressure is applied.

It is somewhat advantageous that the container can be closed off, with regard to its interior, using a cover film/foil, which is not, however, understood to be an integral part of the container in the sense of this invention. The cover film/foil can ideally be connected with the top edge of the container mantle in liquid-tight and/or gas-tight manner; this also applies for the reinforcement element that runs along the partition, if present, which in turn forms a connection surface with the cover film/foil. The cover film/foil can have a recess in the region of a steam entry, if present, so that filling the steam in is possible even when the cover film/foil is in place. Alternatively, the cover film/foil can be cut separately in the region of the steam entry, in order to open the steam entry. The cover film/foil is connected with the container by means of gluing, embossing or welding, and can be pulled off the container easily and without residues after heating.

It is somewhat advantageous that the container provided is configured essentially in the shape of a truncated cone and thereby as a cup. The preferred production materials are polypropylene, polyethylene including C-PET, glass, aluminum or paperboard. Likewise, it is easily possible to use a mixture or compilation of these materials for the production of the container.

The invention described above will be explained in greater detail using an exemplary embodiment.

The figures show:

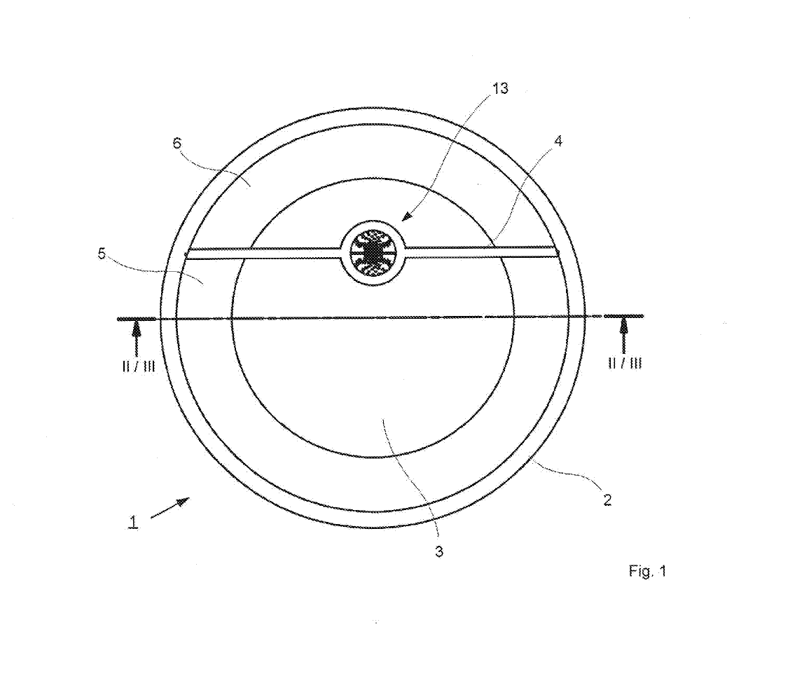

FIG. 1 a container having a partition, in a top view from above,

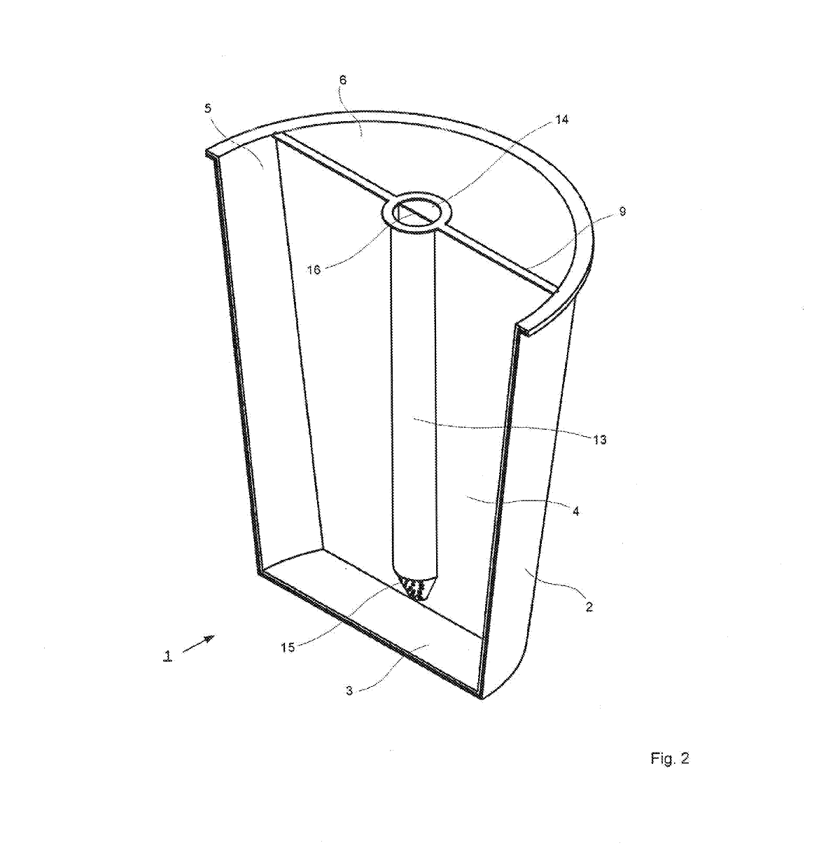

FIG. 2 the container according to FIG. 1, with a cut end as indicated in FIG. 1, with a partition set in, in a perspective representation at a slant from above,

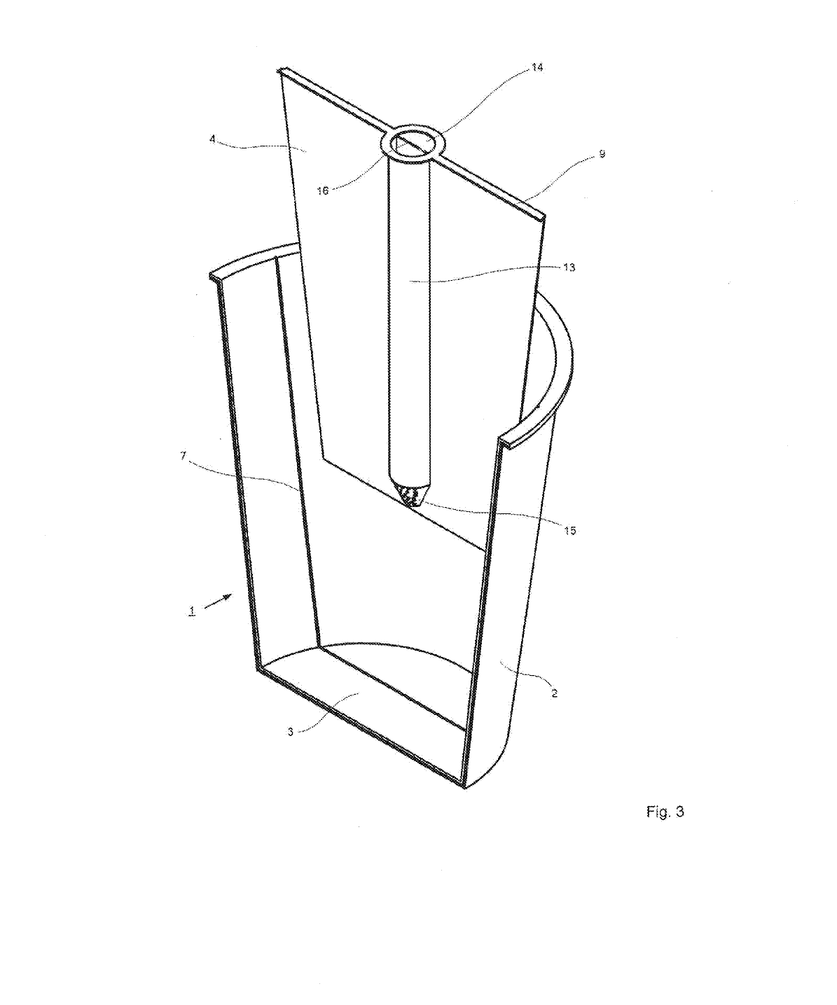

FIG. 3 the container according to FIG. 2 with the partition half lifted out, in a perspective representation at a slant from above,

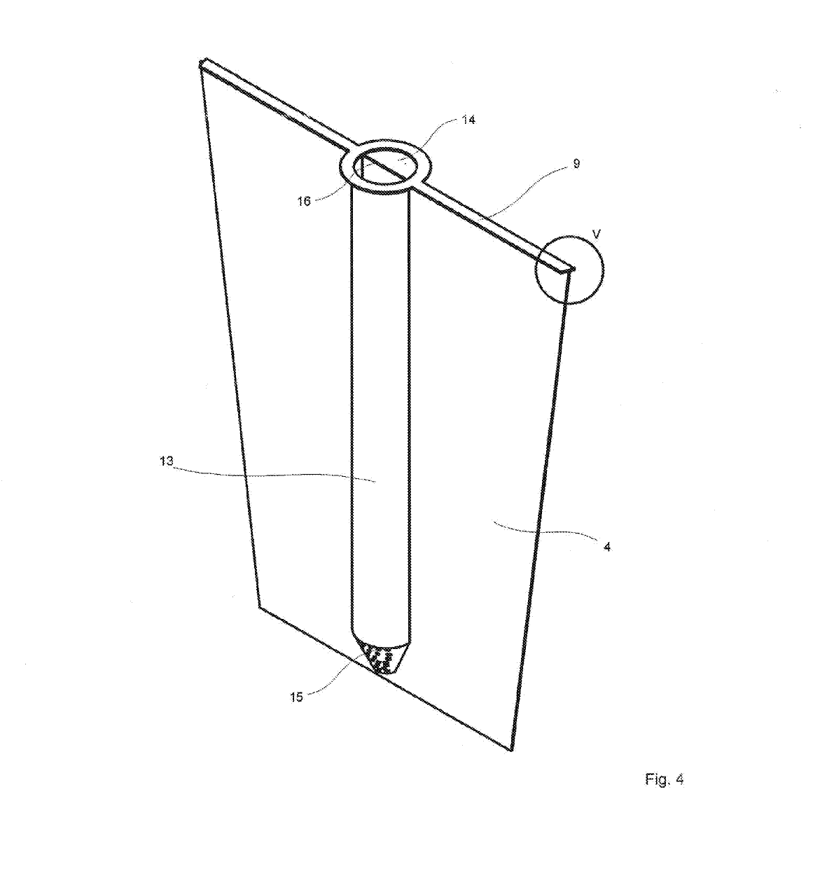

FIG. 4 the removed partition from FIGS. 1 to 3 in a separated representation, in perspective at a slant from above,

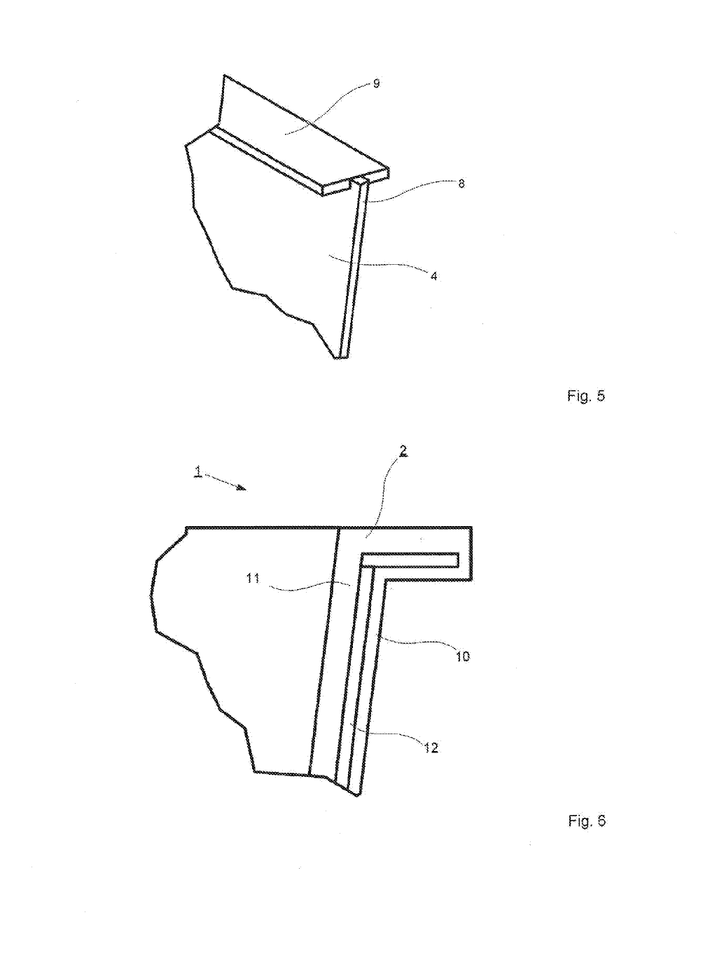

FIG. 5 a detail representation from FIG. 4,

FIG. 6 a detail representation of a section through the edge of the container according to the present invention, in a detail representation of a cross-sectional representation, as well as

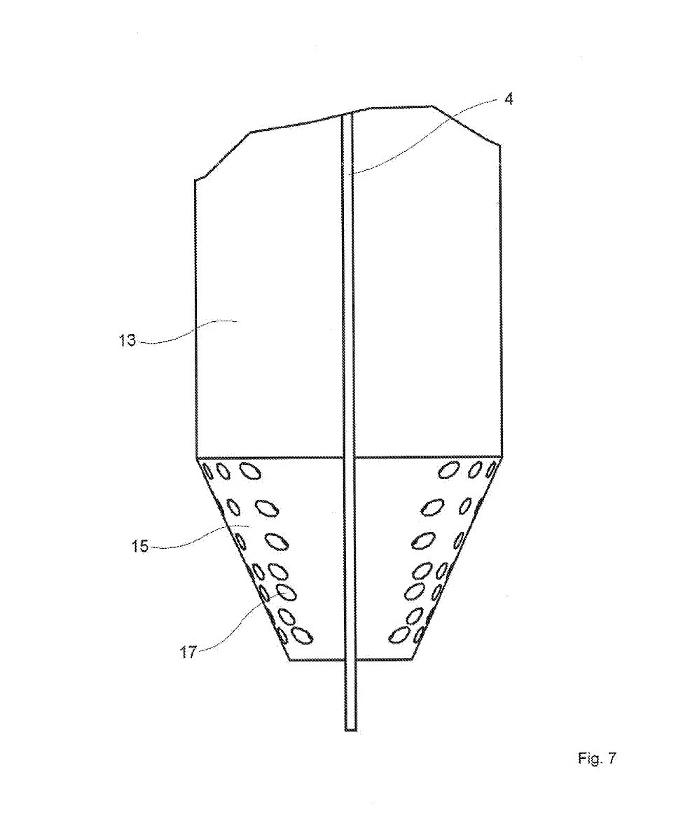

FIG. 7 a detail representation of a cross-section of the partition in the region of the container bottom.

FIG. 1 shows a container 1 having a container mantle 2, which narrows comically and has a container bottom 3. The interior of the container 1 is divided into a first sub-area 5 and a second sub-area 6, using a partition 4. A first product part can be contained in the first sub-area 5, in this regard, which product part is supposed to be kept separate from a second product part, which is accommodated in the second sub-area 6. For example, the product in the first sub-area 5 can be pasta, while the product in the second sub-area 6 is a related sauce. The partition 4 has a steam pipe 13 disposed in the center, which is configured to be cylindrical and is divided into two halves by a central pipe partition 16.

FIG. 2 shows the container 1 in a perspective view, in which the longitudinal expanse of the steam pipe 13 can be recognized. The steam pipe 13, divided by the pipe partition 16, runs from a top edge of the partition 4 all the way into the region of the container bottom 3, where the steam pipe 13 opens into a steam outlet 15 in the shape of a truncated cone. To heat the product contained in the container 1, a steam feed can now be connected by way of a steam entry 14, which is formed at the end of the steam pipe 13 that faces away from the container bottom 3, and blows steam into the steam pipe 13. This steam will be distributed into the sub-areas 5 and 6 disposed on both sides of the steam pipe 13, by way of the steam outlet 15, so that the product parts contained therein will be heated separately, in each instance. The steam blown into the steam pipe 13 by the steam feed will, in turn, also not mix, because of the pipe partition 16, but rather will be separately conducted to the two sub-areas 5 and 6.

FIG. 3 shows destruction-free removal of the partition 4 from the container 1, which can take place by means of simply lifting the partition 4 out of the container 1. In this regard, the partition 4 is held in its position in a groove 7 in the container mantle 2 and container bottom 3, so that it can be removed from the container by means of simply lifting it out. In this moment, the two product parts that had been contained in the two sub-areas 5 and 6 will encounter one another in a common interior of the container 1, and will penetrate one another from both sides. Further mixing can be undertaken also with the partition 4, since it can also be removed by simply stripping it off at the container edges.

FIG. 4 shows the removed partition 4 in detail, once again. The partition 4 is reinforced by way of a reinforcement element 9, which faces away from the container bottom 3, according to its intended purpose, which element is formed onto the partition 4. As a result, the partition 4 possesses a T shape, in cross-section, so that bending is prevented; such bending would lead to the edges of the partition 4 slipping out of the groove 7 in container mantle 2 and container bottom 3. Furthermore, the reinforcement element 9 forms a surface by way of which a cover film/foil, not shown in any detail here, which can be easily pulled off, can be connected with the partition 4, in order to prevent the product parts from passing into the other sub-area 5 or 6, in each instance, for example due to tilting of the formed in such a manner that it is conducted around the steam pipe 13, so that the steam entry 14 of the steam pipe 13 could also be directly connected with the cover film/foil.

FIG. 5 shows a detail of the partition 4, marked in FIG. 4, in which the T-shaped configuration is made clear, for one thing; for another thing, it becomes clear that a non-narrowed tongue 8 is formed at the edge of the partition 4, which can be introduced into the groove 7 of the container 1.

FIG. 6 shows a detail of the cup mantle 2, which is configured to be essentially hollow. For this purpose, the container 1 has an outer wall 10 and an inner wall 11 in the region of its wails, between which an insulation core 12 is enclosed. This insulation core can particularly be filled with air, but can also contain a different insulating material. In this way, it is guaranteed that a transfer of the temperature that prevails within the container 1 is not passed on to the outside, in other words to the hands of the consumer. This prevents burns to the consumer, for one thing, and for another, it keeps the product that has been heated in the container 1 warm.

FIG. 7 finally shows a detail of the steam pipe 13, there particularly the steam outlet 15. The steam pipe 13 is divided into two halves by the partition 4 and, in particular, by the pipe partition 16 that runs within the steam pipe 13, in which halves the steam can be conducted separately for the two sub-areas 5 and 6. In this regard, the steam outlet 15 has a plurality of steam exit openings 17, by way of which the steam can escape from the steam pipe 13 into the respective sub-area 5 or 6.

What is described above is therefore a container for storage and preparation of foods, which for one thing is easier to handle than the known containers from, the state of the art, because overfilling of individual container parts is prevented on the basis of the design, and on the other hand, the product is made available to the consumer as completely as possible.

Furthermore, the proposed design permits placement of a steam pipe, which allows gentle and efficient heating of the product.

### REFERENCE SYMBOL LIST

1. container

2. container mantle

3. container bottom

4. partition

5. first sub-area

6. second sub-area

7. groove

8. tongue

9. reinforcement element

10. outer wall

11. inner wall

12. insulation core

13. steam pipe

14. steam entry

15. steam outlet

16. pipe partition

17. steam exit openings

1: Container for storage and preparation of foods, which encloses an interior and comprises a container mantle (2) as well as a container bottom (3), wherein the interior is divided into at least two sub-areas (5, 6) that are insulated from one another in liquid-tight manner, using at least one partition (4), wherein
the partition (4) can be removed from the interior, in destruction-free manner, so that the liquid-tight reciprocal insulation of the sub-areas (5, 6) is given, up, and a connection between the sub-areas (5, 6) is produced, wherein a steam pipe (13) for charging the interior with steam is assigned to the partition (4).

2: Container according to claim 1, wherein a groove (7) is assigned to the container mantle (2) and/or to the container bottom (3), to accommodate parts of the partition (4).

3: Container according to claim 2, wherein the partition (4) has a tongue (8) that runs along its outer edge, for introduction into the groove (7) of the container mantle (2) and/or of the container bottom (3).

4: Container according to claim 1, wherein the partition (4) has a reinforcement element (9) on its edge facing away from the container bottom (3), in such a manner that the partition (4) has an L shape or a T shape in cross-section.

5: Container according to claim 4, wherein the reinforcement element is a fold or a formed-on reinforcement element (9).

6: Container, according to claim 1, wherein the container mantle (2) and/or the container bottom (3) has/have an outer wall (10) and an inner wall (11), which enclose an insulation core (12) between them, composed of a heat-insulating solid or liquid material or of a gas.

7: Container according to claim 1, wherein the partition (4) has a steam pipe (13) that is accessible by way of a steam entry (14), at the edge facing away from the container bottom, which pipe ends in a steam outlet (15) in the region of the container bottom (3).

8: Container according to claim 7, wherein the steam pipe (13) in turn is divided, in liquid-tight manner, by means of at least one pipe partition (16).

9: Container according to claim 7, wherein the steam pipe (13) is formed as a cylindrical or polygonal pipe, which narrows in spherical shape, conical shape, or truncated conical shape in the region of the container bottom (3).

10: Container according to claim 7, wherein the steam pipe (13) has at least one steam outlet opening (17) that forms the steam outlet, in the region of the container bottom (3).

11: Container according to claim 7, wherein a connection means for a steam-tight connection with a steam feed device is assigned to the steam entry (14).

12: Container according to claim 11, wherein the interior is covered by a cover film/foil on its side facing away from the container bottom (3) and is closed off in liquid-tight and/or gas-tight manner.

13: Container according to claim 12, wherein the cover film/foil has a recess in the region of the steam entry (14).

14: Container according to claim 1, which is formed essentially in the shape of a truncated cone.

15: Container according to claim 1, which is produced from polypropylene, polyethylene, glass, aluminum or paperboard.
